(19) United States
(12) Patent Application Publication
(10) Pub. No.: US 2010/0238048 A1
(43) Pub. Date: Sep. 23, 2010

(54) APPARATUS AND METHOD FOR GENERATING LOCATION INFORMATION

(75) Inventors: Young-Su Cho, Seoul (KR); Seong Yun Cho, Daejeon (KR); Byung Doo Kim, Daejeon (KR); Wan Sik Choi, Daejeon (KR); Jong-Hyun Park, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/741,723

(22) PCT Filed: Jun. 10, 2008
(86) PCT No.: PCT/KR08/03230

§ 371 Date: May 6, 2010

(30) Foreign Application Priority Data
Nov. 15, 2007 (KR) 10-2007-0116472

(51) Int. Cl. G08B 5/22

(52) U.S. Cl. 340/825.49

(57) ABSTRACT

An apparatus for generating location information transmits an SUPL INIT message for measuring a location to a target terminal so as to position the target terminal. The target terminal transmits an SUPL POS INIT message including RFID tag information to the apparatus. The apparatus determines a positioning method of the target terminal by using RFID tag information, generates the location of the target terminal according to the determined positioning method, and transmits the location to a service user.

### TECHNICAL FIELD

The present invention relates to an apparatus and a method for generating location information. More particularly, the present invention relates to an apparatus and a method for generating location information by using radio frequency identification (RFID).

This work was supported by the IT R&D program of MIC/IITA [2007-F-040-01, Development of Indoor/Outdoor Seamless Positioning Technology].

### BACKGROUND ART

A general network-based positioning technique uses the secure user plane location (SUPL) to generate independent location information of a target terminal, and uses a wide area network (WAN) so that a service user may request location information at any place. Positioning methods applicable to the network-based positioning technique include the assisted global positioning system (GPS), the autonomous GPS, the advanced forward link trilateration (AFLT), the enhanced observed time difference (EOTD), and the observed time difference of arrival (OTDOA).

However, the network-based positioning technique can be used outside buildings since it has location precision from several tens to several hundreds of meters, and it is inappropriate for a service such as GPS and asset tracking in an interior condition (e.g., in buildings and under ground) requiring location precision of several meters.

The RFID-based positioning technique provides relatively high accuracy in buildings, but it requires an SUPL location platform for each service area since it is a non-network-based positioning method, and it limits the service user's location request.

Further, in order for a target terminal to provide continuous positioning service inside/outside the building and precise location service inside the building, composite positioning between a global navigation satellite system (GNSS) outside the building and various wireless communication infrastructures inside the building is needed.

### DISCLOSURE OF INVENTION

### Technical Problem

The present invention has been made in an effort to provide a method and device for generating location information of a target terminal inside/outside a building.

To achieve the object, the present invention uses an SUPL process in the RFID-based condition to generate location information of a target terminal.

### Technical Solution

In one aspect of the present invention, a method for generating location information of a target terminal is provided, which includes transmitting an SUPL INIT message for measuring location information of the target terminal to the target terminal, receiving an SUPL POS INIT message having radio frequency identification (RFID) tag information from the target terminal, determining a positioning method of the target terminal by using the RFID tag information, and generating the location of the target terminal according to the positioning method. The method further includes transmitting the location of the target terminal to a service user through the mobile location protocol SLIA message.

In another aspect of the present invention, a method for generating location information of a target terminal, which includes receiving a service request message for generating location information of the target terminal from a service user, transmitting a first message to the target terminal, receiving a second message including RFID tag information from the target terminal, and determining the positioning method of the target terminal according to the number of the RFID tag information.

In another aspect of the present invention, an apparatus for generating location information of a target terminal is provided, which includes a message processor for transmitting an SUPL INIT message to the target terminal, and receiving an SUPL POS INIT message having RFID tag information for performing a location information generating service of the target terminal from the target terminal when receiving a request on the service from a service user, and a location generator for generating the location of the target terminal by determining the positioning method of the target terminal by using the RFID tag information. The device further includes a location transmitter for transmitting the location of the generated target terminal to the service user.

### Advantageous Effects

According to the exemplary embodiment of the present invention, it is possible to generate location information of a target terminal by using the SUPL process in the condition in which RFID signals can be received, and provide the location information to a service user.

Also, according to the exemplary embodiment of the present invention, it is possible to extend the positioning technique to be selectable by the target terminal by adding the RFID that is a non-network-based positioning technique to the SUPL process that supports the network-based location technique.

### BRIEF DESCRIPTION OF THE DRAWINGS

An exemplary embodiment of the present invention will be described in detail with reference to the accompanying drawings for clear understanding of advantages of the present invention, wherein:

FIG. 1 is a location information generation system according to an exemplary embodiment of the present invention;

FIG. 2 is a block diagram of the SUPL location platform shown in FIG. 1;

FIG. 3 is shows a structure of an SUPL INIT message according to an exemplary embodiment of the present invention;

FIG. 4 shows a structure of an SUPL POS INIT message according to an exemplary embodiment of the present invention;

FIG. 5 shows a structure of the location identifier parameter shown in FIG. 4;

FIG. 6 shows a structure of the cell information shown in FIG. 5;

FIG. 7 shows a structure of the RFID tag information shown in FIG. 6; and

FIG. 8 shows a flowchart for generating location information of a target terminal in an RFID-based location information generate system according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements.

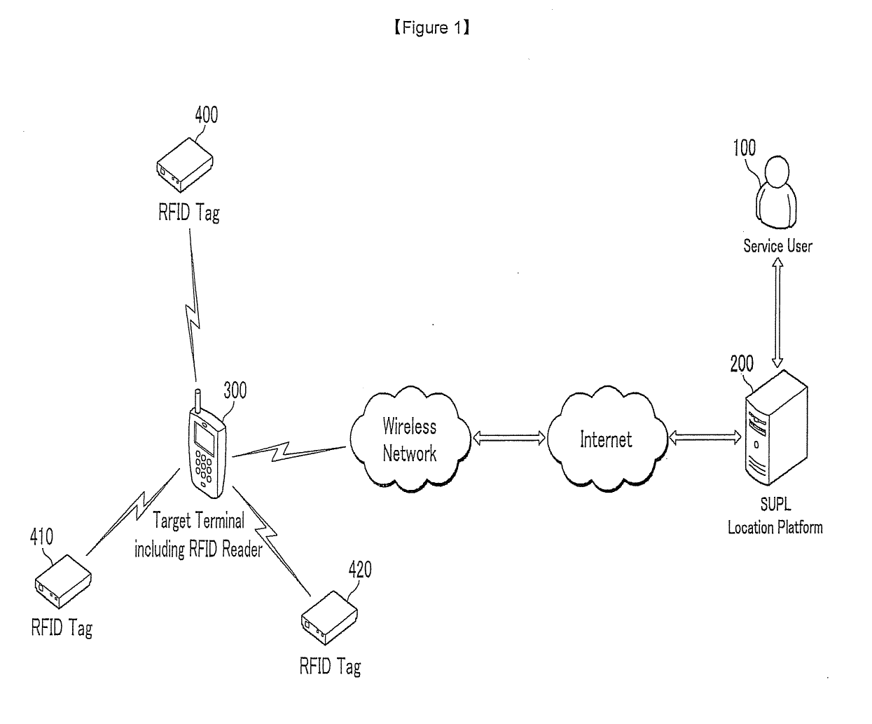

A location information generating system on the network in which an RFID infrastructure is installed according to an exemplary embodiment of the present invention will now be described in detail with reference to FIG. 1 and FIG. 2.

FIG. 1 is a location information generation system according to an exemplary embodiment of the present invention, and FIG. 2 is a block diagram of the SUPL location platform shown in FIG. 1.

As shown in FIG. 1, the location information generate system includes a service user 100, an SUPL location platform (or a location server) 200, a target terminal 300 in which an RFID reader is installed, RFID tags 400, 410, and 420, and a wireless network.

The service user 100 (e.g., an SUPL agent) includes a logical service access pointer using measured location information, and accesses the SUPL location platform 200 for supporting the SUPL process in order to request the location of the target terminal 300. The service user 100 requests a single request service or a repeated request service from the SUPL location platform 200 by using a mobile location protocol (MLP). The service user 100 transmits a standard location immediate request (SLIR) message of the MLP to the SUPL location platform 200 so as to request the single request service, and transmits a triggered location reporting request (TLRR) message to the SUPL location platform 200 so as to request the repeated request service. In this instance, the single request service is a service that responds once to the user's service request, and the repeated request service is a service that periodically responds when the user's service request corresponds to a predetermined time interval or range. It is assumed in the exemplary embodiment of the present invention that the single request service is requested. However, the present invention is not restricted to this and it may generate location information of the target terminal when a repeated request service is requested.

Here, the SUPL process represents the protocol between the SUPL location platform 200 and the target terminal 300 when a location service is provided not through a control plane but through a user plane, and it is independent in the location-tracked network structure. The location request service using the SUPL process calculates the location of the target terminal 300 and performs the service by using a location determination method that is supportable on the current network according to the request by the service user 100.

The SUPL location platform 200 is an SUPL service access point on the network part for accessing the network resource so as to acquire location information of the target terminal 300, and it calculates a location value of the target terminal 300 requested by the service user 100 by using the SUPL process. Referring to FIG. 2, the SUPL location platform 200 includes a message processor 210, a location generator 220, and a location transmitter 230.

When receiving a mobile location protocol SLIR message that is a location request message from the service user 100, the message processor 210 determines whether the target terminal 300 is roaming and whether the target terminal 300 uses the SUPL process. It is assumed in the exemplary embodiment of the present invention that the target terminal 300 is not roaming and uses the SUPL process.

When checking that the target terminal 300 is not roaming and uses the SUPL process, the message processor 210 transmits an SUPL INIT message for initializing a location session to the target terminal 300 to start a single request service.

In this instance, when receiving an SUPL POS INIT message from the target terminal 300 having received the SUPL INIT message, the location generator 220 determines the final positioning method used for the SUPL positioning process according to a positioning method included in a SET capability parameter 630 of FIG. 4 of the received message, and calculates a location of the target terminal 300 through the determined final positioning method. For example, the location generator 220 compares a positioning method that is supportable by the SUPL location platform 200 included in the SUPL INIT message and a positioning method included in the SET capability parameter 630 of the SUPL POS INIT message received from the target terminal 300 to determine the final positioning method. The location generator 220 according to the exemplary embodiment of the present invention uses a cell identification method and a signal strength method so as to position the target terminal 300.

When the location of the target terminal 300 is determined through the above-noted methods, the location transmitter 230 transmits an SUPL END message to the target terminal 300 and finishes the positioning process so that no additional positioning process may be performed. The location transmitter 230 transmits the position of the target terminal 300 generated through a mobile location protocol SLIA message to the service user 100.

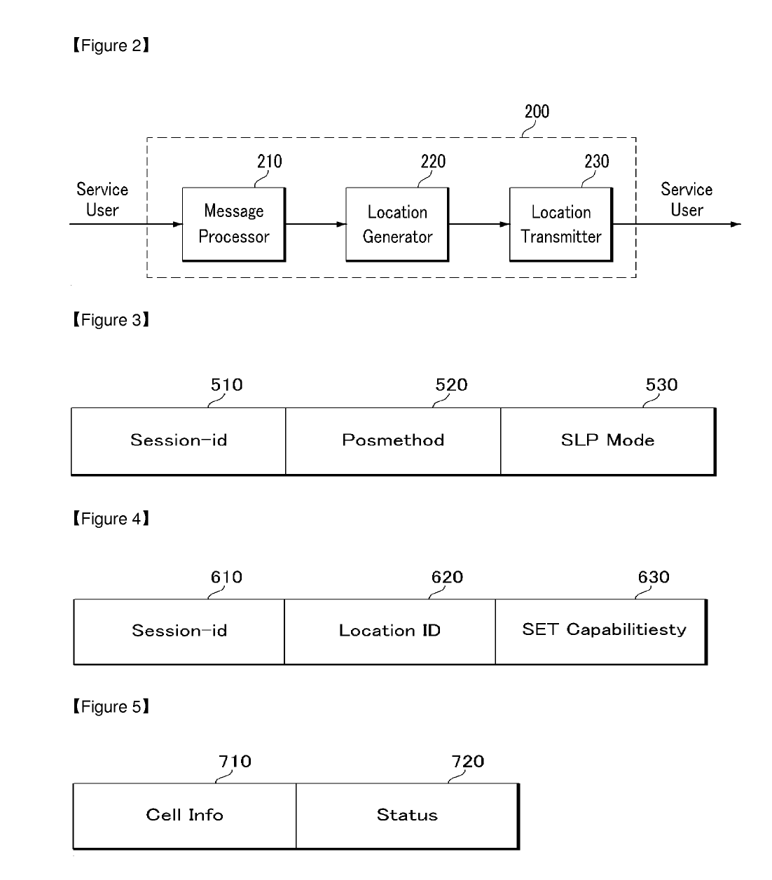

Messages and parameters for position-calculating the target terminal by using the SUPL process according to an exemplary embodiment of the present invention will now be described in detail with reference to FIG. 3 to FIG. 7.

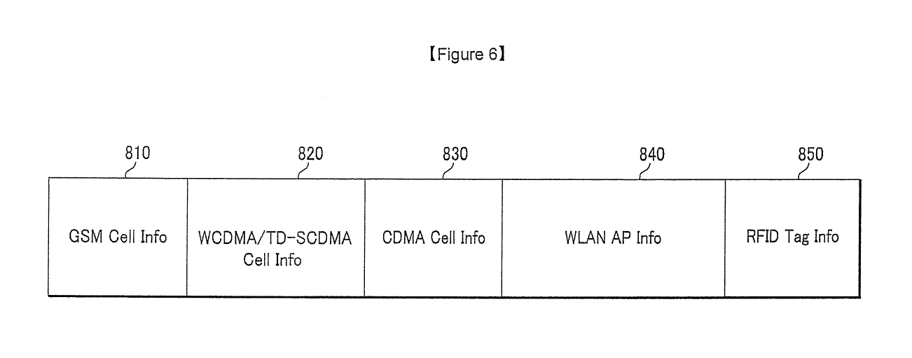

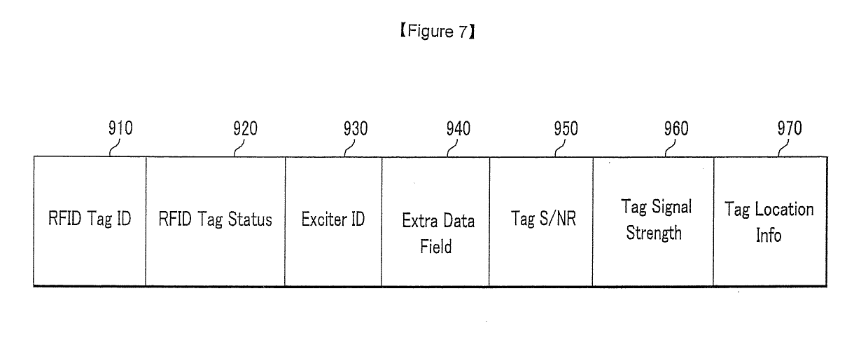

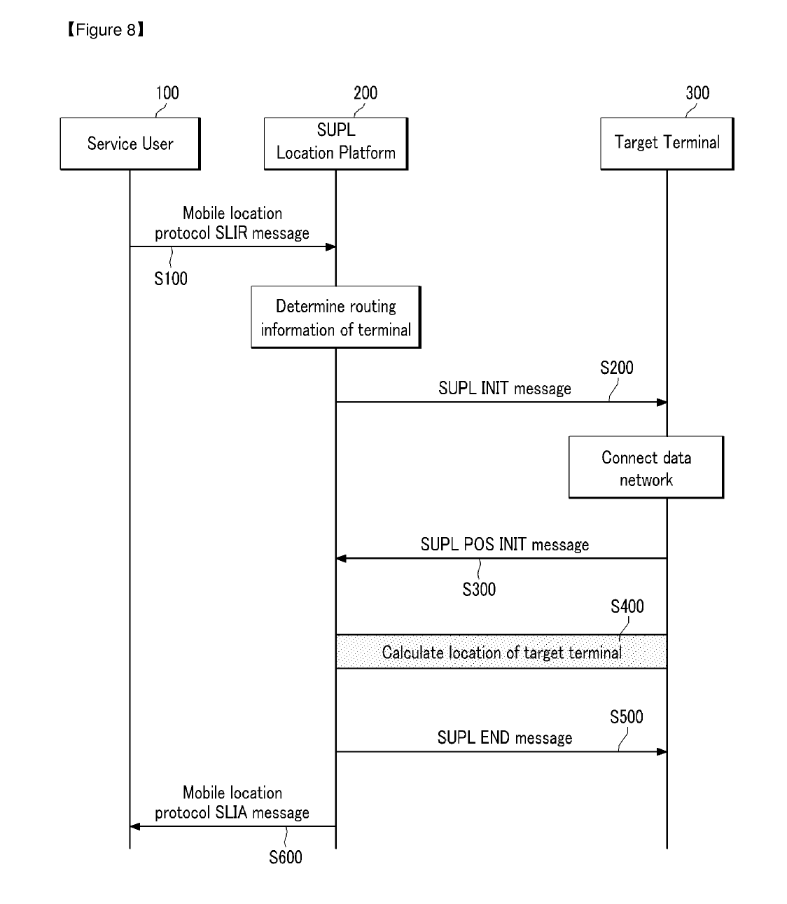

FIG. 3 shows a structure of an SUPL INIT message according to an exemplary embodiment of the present invention. FIG. 4 shows a structure of an SUPL POS INIT message according to an exemplary embodiment of the present invention, and FIG. 5 shows a structure of the location identifier parameter shown in FIG. 4. FIG. 6 shows a structure of the cell information shown in FIG. 5, and FIG. 7 shows a structure of the RFID tag information shown in FIG. 6.

Referring to FIG. 1 and FIG. 3, the SUPL INIT message is a message that is transmitted from the SUPL location platform 200 to the target terminal 300 so as to start a single request service, and it includes a session identification parameter (Session-id) 510, a positioning method parameter (Posmethod) 520, an SLP mode parameter (SLP mode) 530, a trigger type parameter (not shown), and a supported network information parameter (not shown).

The session identification parameter 510 is a parameter for indicating an identifier for identifying transmitted/received messages between the SUPL location platform 200 and the target terminal 300.

The positioning method parameter 520 is a parameter for indicating the positioning method that is available when the SUPL location platform 200 generates the location of the target terminal 300. For example, the global system for mobile communication (GSM) network uses the radio resource LCS protocol (RRLP), the wideband code division multiple access (WCDMA) network uses the radio resource control (RRC), and the code division multiple access (CDMA) network uses the IS-801.

The SLP mode parameter 530 is a parameter for indicating whether the SUPL location platform 200 is divided into a position calculation server (not shown) and a message management server (not shown). That is, when the position calculation server and the message management server of the SUPL location platform 200 are combined into one unit, the SLP mode 530 becomes a proxy mode. When the position calculation server and the message management server of the SUPL location platform 200 are divided, the SLP mode 530 becomes a non-proxy mode.

When the SUPL INIT message having a structure shown in FIG. 3 is transmitted from the SUPL location platform 200 to the target terminal 300, the target terminal 300 checks the connection state to the data network, and attempts to connect to the data network when it is found to be disconnected from the data network. In this instance, the target terminal 300 determines whether the mode is a proxy mode or a non-proxy mode from the SLP mode 530 included in the SUPL INIT message. When the mode is found to be a proxy mode, the target terminal 300 connects to the SUPL location platform 200 through the Internet protocol (IP).

Referring to FIG. 1 and FIG. 4, the SUPL POSINIT message is transmitted from the target terminal 300 to the SUPL location platform 200, and it includes a session identification parameter (Session-id) 610, a location identifier parameter (Location ID) 620, and a SET capability parameter (SET capability) 630.

The session identification parameter 610 is a parameter for indicating an identifier for identifying the message transmitted/received between the SUPL location platform 200 and the target terminal 300.

The location identifier parameter 620 includes cell information (Cell Info) 710 currently provided to the target terminal 300, wireless local area network (WLAN) access point information, and status information (Status) 720 such as RFID tag information, as shown in FIG. 5.

The SET capability parameter 630 is a parameter for defining a positioning method and a protocol supported by the target terminal 300.

Referring to FIG. 5 and FIG. 6, the cell information 710 according to the exemplary embodiment of the present invention includes GSM cell information (GSM Cell Info) 810, wideband code division multiple access/time-division synchronous CDMA (WCDMA/TD-SCDMA) cell information (WCDMA/TD-SCDMA Cell Info) 820, CDMA cell information (CDMA Cell Info) 830, wireless local area network access point (WLAN AP) information (WLAN AP Info) 840, and a RFID tag information (RFID Tag Info) 850.

Here, as shown in FIG. 6 and FIG. 7, the RFID tag information 850 according to the exemplary embodiment of the present invention includes an RFID tag identifier (ID) 910, an RFID tag status 920, an exciter identifier 930, an extra data field 940, a tag signal-to-noise ratio (SNR) 950, a tag signal strength 960, and tag location information (Tag Location Info) 970.

The RFID tag identifier 910 is a parameter for indicating a proper identifier of the received RFID tag.

The RFID tag status 920 is a parameter for defining RFID tag configuration information and battery information.

The exciter identifier 930 is a parameter for indicating a corresponding exciter identifier when the RFID tag comes in or goes out of the exciter field.

The extra data field 940 is a parameter for indicating information on a product or a person to which RFID tag is applied.

The tag SNR 950 is a parameter for indicating the SNR of the RFID tag signal received by the RFID reader.

The tag signal strength 960 is a parameter for indicating signal strength of the RFID tag received by the RFID reader.

The tag location information 970 is a parameter for indicating tag location, and indicates an address represented by various formats of coordinate systems including a newly defined local coordinate system, a wide area coordinate system (e.g., WGS 84), and a postal address.

The RFID-based network according to the exemplary embodiment of the present invention positions the target terminal 300 by using the RFID tag information 850 shown in FIG. 6 and FIG. 7.

FIG. 8 shows a flowchart for generating location information of a target terminal in an RFID-based location information generate system according to an exemplary embodiment of the present invention.

As shown in FIG. 8, in order to generate location information in the RFID-based location information generating system, the service user 100 transmits a mobile location protocol SLIR message to the SUPL location platform 200 (S100).

In this instance, when receiving the mobile location protocol SLIR message from the service user 100, the SUPL location platform 200 determines whether the target terminal is roaming and whether the target terminal uses the SUPL process. When it is found that the target terminal 300 is not roaming and uses the SUPL process, the SUPL location platform 200 transmits the SUPL INIT message shown in FIG. 3 to the target terminal 300 and starts the single request service (S200).

When receiving the SUPL INIT message from the SUPL location platform 200, the target terminal 300 checks the connection state to the data network, and attempts to connect to the data network when it is found to be disconnected from the data network. The target terminal 300 transmits the SUPL POS INIT message shown in FIG. 4 to the SUPL location platform 200 (S300). In this instance, the target terminal 300 reads RFID tag information from the product or person to which the RFID tag is applied, and generates an SUPL POS INIT message.

The SUPL location platform 200 compares a positioning method included in the positioning method parameter 520 of the SUPL INIT message shown in FIG. 3 and a positioning method included in the SET capability parameter 630 of the SUPL POS INIT message received from the target terminal shown in FIG. 4 to determine the final positioning method.

In detail, when one piece of RFID tag information is received, the location generator 220 calculates the location of the target terminal 300 according to a cell Identification method using the tag identifier 910 in the currently provided RFID tag information shown in FIG. 7 (S400). Since one piece of RFID tag information is received, the location generator 220 calculates the location of the received RFID tag by searching the database matched with the tag identifier 910 or through tag location information 970 so as to generate more accurate positioning. The location generator 220 estimates a possible location area of the target terminal 300 by using the tag signal strength 960 or RFID tag coverage information. In this instance, the location error is variable by the coverage of the RFID tag, and in detail, the passive tag has the coverage of several meters, and the active tag has the coverage of several tens of meters.

When a plurality pieces of RFID tag information are received, the location generator 220 determines the location of the target terminal 300 according to the signal strength method based on a pattern matching method or a propagation model method by using the tag identifier 910 and the tag signal strength 960 in the currently provided RFID tag information shown in FIG. 7.

When the location of the target terminal 300 is determined through the positioning method determined by the SUPL location platform 200, the SUPL location platform 200 transmits an SUPL END message to the target terminal 300 to finish the positioning process so that no additional positioning process may be performed (S500). The SUPL location platform 200 transmits the estimated location of the target terminal 300 to the service user 100 through the mobile location protocol SLIA message (S600).

In the exemplary embodiment of the present invention, since an RFID is added to the network supporting the SUPL process so as to provide the location information service of the target terminal, it is possible to estimate the more accurate location in the interior condition with weak wireless network signals. Here, the RFID unit includes an RFID tag, an RFID reader, and a data processing system, and can measure the location in the relative accurate manner in the building by selecting an appropriate RFID tag type and optimizing the number and arrangement of the RFID tags or RFID readers.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for generating location information of a target terminal, the method comprising:
transmitting an SUPL INIT message for measuring location information of the target terminal to the target terminal;
receiving an SUPL POS INIT message having a radio frequency identification (RFID) tag information from the target terminal;
determining a positioning method of the target terminal by using the RFID tag information; and
generating the location of the target terminal according to the positioning method.

2. The method of claim 1, further comprising:
receiving a mobile location protocol standard location immediate request (SLIR) message from the service user and generating the SUPL INIT message; and
transmitting the location of the target terminal to a service user through the mobile location protocol SLIA message.

3. The method of claim 1, further comprising transmitting the SUPL INIT message to the target terminal when the target terminal is not roaming and uses a secure user plane location (SUPL) process.

4. The method of claim 1, wherein the SUPL POS INIT message comprises a location identification parameter having the RFID tag information and a SET capability parameter having a positioning method supported by the target terminal.

5. The method of claim 4, wherein the determination of the positioning method comprises comparing a positioning method included in the SUPL INIT message and a positioning method included in the SET capability and determining the positioning method.

6. The method of claim 1, wherein the RFID tag information comprises a tag identifier for indicating a proper ID of the RFID tag received by the target terminal and a tag location information for indicating the location of the RFID tag.

7. The method of claim 6, wherein the determination of the positioning method comprises determining the positioning method of the target terminal by using the tag identifier when there is one piece of the RFID tag information.

8. The method of claim 6, wherein the RFID tag information further comprises a tag signal strength for indicating signal strength of the RFID tag received by the RFID reader, and
the determination of the positioning method comprises determining the positioning method of the target terminal by using the tag identifier and the tag signal strength when there are a plurality of pieces of the RFID tag information.

9. A method for generating location information of a target terminal, the method comprising:
receiving a service request message for generating location information of the target terminal from a service user;
transmitting a first message to the target terminal;
receiving a second message having radio frequency identification (RFID) tag information from the target terminal; and
determining a positioning method of the target terminal according to the number of the RFID tag information.

10. The method of claim 9, wherein the RFID tag information comprises a tag identifier for indicating a proper ID of the RFID tag received by the target terminal and a tag signal strength for indicating signal strength of the RFID tag.

11. The method of claim 10, wherein the determination of the positioning method comprises determining a cell identification method using the tag identifier as the positioning method of the target terminal when there is one piece of the RFID tag information.

12. The method of claim 10, wherein the determination of the positioning method comprises determining a signal strength method using the tag identifier and the tag signal strength as the positioning method of the target terminal when there are a plurality of pieces of the RFID tag information.

13. An apparatus for generating location information of a target terminal, the apparatus comprising:
a message processor for transmitting an SUPL INIT message to the target terminal, and receiving an SUPL POS INIT message having radio frequency identification (RFID) tag information for performing a location information generating service of the target terminal from the target terminal when receiving a request on the service from a service user; and
a location generator for generating the location of the target terminal by determining the positioning method of the target terminal by using the RFID tag information.

14. The apparatus of claim 13, further comprising a location transmitter for transmitting the location of the generated target terminal to the service user.

15. The apparatus of claim 14, wherein the location generator compares a positioning method included in the SUPL INIT message and a positioning method included in the SUPL POS INIT message, and determines the positioning method of the target terminal.
